(19) United States
(12) Patent Application Publication
(10) Pub. No.: US 2026/0128474 A1
(43) Pub. Date: May 7, 2026

(54) SECONDARY BATTERY

(71) Applicant: SAMSUNG SDI CO., LTD., Yongin-si (KR)

(72) Inventors: MIN GYU JUNG, Yongin-si (KR); Jung Hyun Lee, Yongin-si (KR); Jeong Yi Park, Yongin-si (KR); Hye Min Park, Yongin-si (KR); Gi Wook Lee, Yongin-si (KR)

(21) Appl. No.: 19/215,728

(22) Filed: May 22, 2025

(30) Foreign Application Priority Data
Nov. 5, 2024 (KR) 10-2024-0154902

(51) Int. Cl. H01M 50/474; B60L 50/64; H01M 10/0587; H01M 50/105; H01M 50/483

(52) U.S. Cl. CPC H01M 50/474; H01M 10/0587; H01M 50/105; H01M 50/483; B60L 50/64; H01M 2220/20

(57) ABSTRACT

A secondary battery includes an electrode assembly including a first electrode plate having a first electrode uncoated portion, a second electrode plate having a second electrode uncoated portion, and a separator between the first electrode plate and the second electrode plate, an insulating layer covering the first electrode uncoated portion, a thickness of the insulating layer on the first electrode uncoated portion at an outer side of the electrode assembly being greater than a thickness of the insulating layer on the first electrode uncoated portion at an inner side of the electrode assembly; and a case accommodating the electrode assembly with the insulating layer.

### CROSS-REFERENCE TO RELATED APPLICATION

This application claims priority to and the benefit of Korean Patent Application No. 10-2024-0154902, filed on Nov. 5, 2024, in the Korean Intellectual Property Office, the entire disclosure of which is incorporated herein by reference.

### BACKGROUND

### 1. Field

The present disclosure relates to a secondary battery.

### 2. Description of the Related Art

A secondary battery is a power storage system that converts electric energy into chemical energy and stores the converted energy to provide high energy density. Unlike primary batteries that cannot be recharged, a secondary battery is rechargeable and is being widely used in IT devices, such as a smart phone, a cellular phone, a notebook computer, or a tablet PC. In recent years, electric vehicles are drawing attention for protection of environmental contamination, and a trend toward the use of high-capacity secondary batteries for electric vehicles is growing. The secondary battery needs to have high density, high output and stability characteristics.

The above information disclosed in this Background section is for enhancement of understanding of the background of the present disclosure, and therefore, it may contain information that does not constitute related (or prior) art.

### SUMMARY

A secondary battery according to one embodiment of the present disclosure includes an electrode assembly including a first electrode plate having a first electrode uncoated portion, a second electrode plate having a second electrode uncoated portion, and a separator disposed between the first electrode plate and the second electrode plate, and including an insulating layer provided to cover the first electrode uncoated portion; and a case accommodating the electrode assembly, wherein in the electrode assembly, the thickness of the insulating layer provided on the first electrode plate located at the outermost side may be greater than the thickness of the insulating layer provided on the first electrode plate located at the inner side of the electrode assembly.

The first electrode plate may include a first electrode current collector plate which is a metal foil; a first electrode active material provided on at least one surface of the first electrode current collector plate; and a first electrode uncoated portion at one end in a first direction of the first electrode current collector plate, to which the first electrode active material is not applied.

The insulating layer may have the one end in first direction cover the sidewall of the first electrode active material.

The insulating layer may have a region overlapping the first electrode active material in the first direction.

The first electrode active material may be provided on each of both sides of the first electrode current collector, and the insulating layer may be provided on each of both sides of the first electrode uncoated portion.

The thickness of the insulating layer may be equal to or smaller than the thickness of the first electrode active material.

The thickness of the insulating layer may be 40% to 70% of the thickness of the first electrode active material.

The electrode assembly may be of a stack type in which the first electrode plate, the separator, the second negative electrode plate, and the separator are sequentially and repeatedly stacked in multiple times, and the thickness of the outermost insulating layer provided on the first electrode plate located at the outermost side may be greater than the thickness of the inner insulating layer provided on the first electrode plate located at the inner side

The thickness of the inner insulating layer may be 50% to 90% of the thickness of the outermost insulating layer.

The thickness of the insulating layer provided on the first electrode plate located at the center of the electrode assembly may be smaller than the thickness of the insulating layer provided on another first electrode plate.

The plurality of first electrode plates may each further include a first electrode tab extending in the first direction from the first electrode uncoated portion, and the insulating layer may be provided to partially cover the surface of the multiple first electrode tab.

The insulating layer may have a smaller length in the first direction than the length of the first electrode tab in the first direction.

Multiple first electrode tabs are aligned and stacked at the same position.

The electrode assembly may be of a jelly-roll type in which the first electrode plate, the separator, the second negative electrode plate, and the separator are sequentially stacked in a plate or film shape.

The insulating layer may gradually increase in thickness from the winding leading edge to the winding trailing edge.

The thickness of the insulating layer provided to cover the outer surface of the first electrode uncoated portion may be greater than the thickness of the insulating layer provided to cover the inner surface of the first electrode uncoated portion.

The insulating layer located at the winding trailing edge region, which is the outermost side of the electrode assembly, may be provided to have a larger thickness than the insulating layer provided at the inner region, which is the inner side of the electrode assembly, and the winding trailing edge region corresponds to the length in which the first electrode plate located at the outermost side is wound at least once.

The insulating layer provided in the inner region may have a uniform thickness.

The first electrode plate may be a positive electrode plate, and the second electrode plate may be a negative electrode plate.

The insulating layer may be made of ceramic.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing a secondary battery according to the present disclosure.

FIG. 2 is an exploded perspective view of the secondary battery in FIG. 1.

FIG. 3 is an exploded perspective view of portions of the electrode assembly in the secondary battery of FIGS. 1 and 2.

FIG. 4 is a cross-sectional view taken along line 4-4′ of FIG. 3.

FIG. 5 is an enlarged view of portion 5 of FIG. 4.

FIG. 6 is a cross-sectional view of the electrode assembly of FIG. 2.

FIG. 7 is a perspective view showing another example of the electrode assembly in the secondary battery of FIGS. 1 and 2.

FIG. 8 is a plan view showing the electrode assembly of FIG. 7 before a first electrode plate is wound.

FIG. 9 is an example of a cross-sectional view taken along line 9-9′ of FIG. 8.

FIG. 10 is another example of a cross-sectional view along line 9-9′ of FIG. 8.

FIGS. 11A and 11B are perspective views showing a battery pack including an exemplary secondary battery according to the present disclosure.

FIGS. 12A and 12B are, respectively, a perspective view and a side view showing vehicles each including an exemplary battery pack according to the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

It will be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

In addition, it will be understood that the terms “comprise or include” and/or “comprising or including,” when used in this specification, specify the presence of stated features, integers, steps, operations, elements, and/or components but do not preclude the presence or addition of one or more other features, integers, steps, operations, elements, components, and/or groups thereof.

In addition, for a better understanding of the invention, in the attached drawings the dimensions of some components may be exaggerated. In addition, the same reference numbers may be assigned to the same components in different embodiments throughout.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, the singular forms “a” and “an” are intended to include the plural forms as well, unless the context clearly indicates otherwise.

The arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

Also, it will be understood that when an element is referred to as being “on,” “connected to,” or “coupled to,” another element, these elements can be directly connected or coupled to each other, another intervening element may be present therebetween, or the respective elements may be connected, coupled, or linked to each other through another elements. In addition, it will be understood that when an element is referred to as being electrically coupled to another element, the element can be directly connected to another element or an intervening element may be present therebetween such that the element and another element are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing particular embodiments only and is not intended to be limiting of the present disclosure.

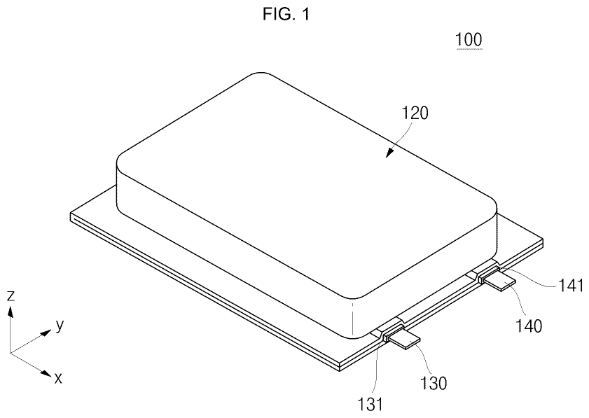

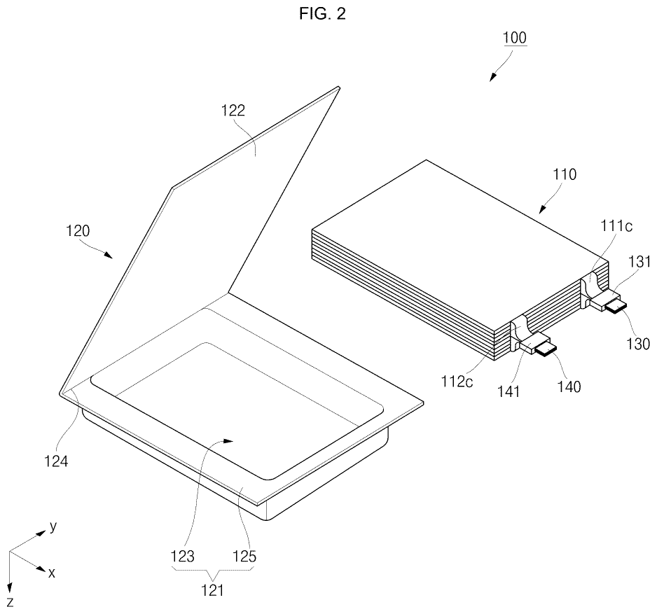

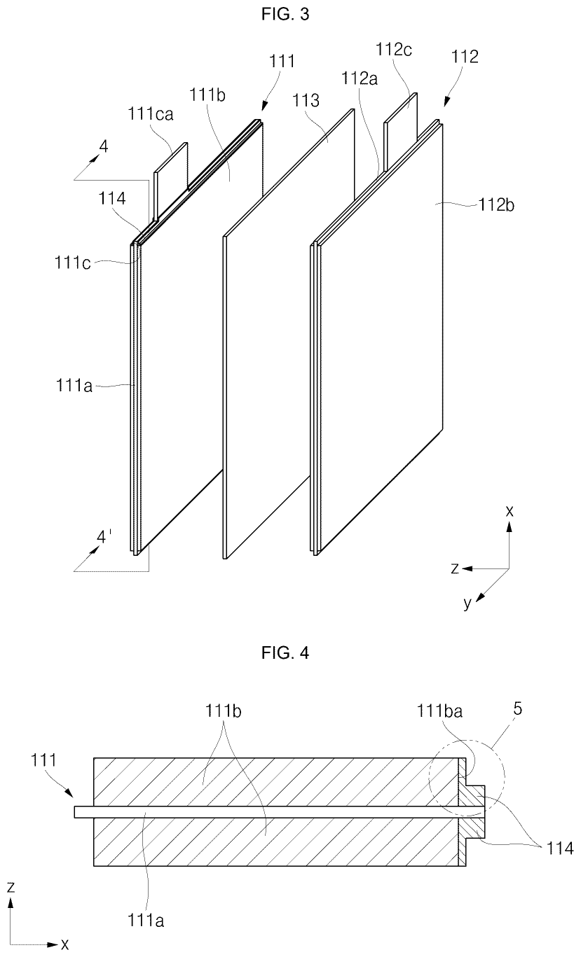

FIG. 1 is a perspective view showing a secondary battery according to the present disclosure, and FIG. 2 is an exploded perspective view of the secondary battery shown in FIG. 1. FIG. 3 is an exploded perspective view of portions of the electrode assembly in the secondary battery of FIGS. 1 and 2.

Referring to FIGS. 1 and 2, a secondary battery 100 may include an electrode assembly 110 and a case 120 that accommodates the electrode assembly 110 and an electrolyte (optional) therein. The electrode assembly 110 may include a separator 113 and a first electrode plate 111 and a second electrode plate 112 positioned with the separator 113 interposed therebetween (FIG. 3). The electrode assembly 110 may have the first electrode plate 111, the separator 113, the second electrode plate 112, and the separator 113 sequentially stacked or wound in a jelly-roll shape.

The secondary battery 100 may include a first electrode lead tab 130 electrically connected to the first electrode plate 111 of the electrode assembly 110, and a second electrode lead tab 140 electrically connected to the second electrode plate 112 of the electrode assembly 110. In addition, a first insulation tape 131 may be interposed between the first electrode lead tab 130 and the case 120, and a second insulation tape 141 may be interposed between the second electrode lead tab 140 and the case 120.

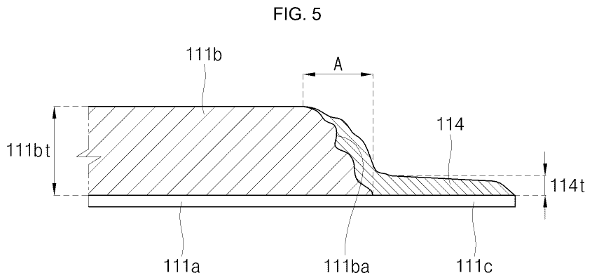

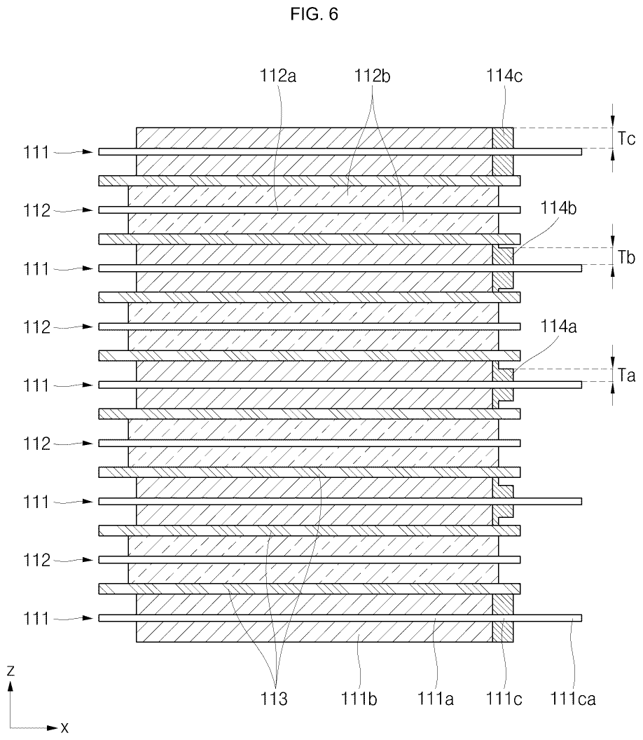

FIG. 4 is a cross-sectional view taken along line 4-4′ of FIG. 3, and FIG. 5 is an enlarged view of portion 5 of FIG. 4. In addition, FIG. 6 is a cross-sectional view of the electrode assembly 110 of FIG. 2. Hereinafter, the electrode assembly 110 of the secondary battery 100 will be described in detail with reference to FIGS. 3 to 6.

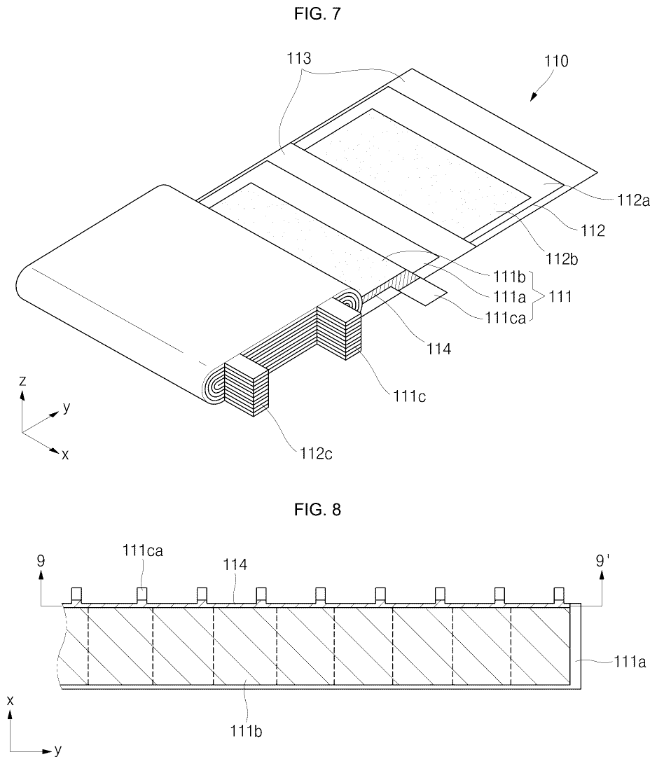

For example, as shown in FIGS. 3 to 6, the electrode assembly 110 may be of a stack type in which a stack of the first electrode plate 111, the separator 113, the second electrode plate 112, and an additional separator 113 may be repeatedly stacked multiple times. In another example, as shown in FIG. 7, the electrode assembly 110 may be of a roll type in which the stack of the first electrode plate 111, the separator 113, the second electrode plate 112, and the additional separator 113 is wound. (e.g., the electrode assembly 110 may be referred to as a jelly roll).

First, as shown in FIGS. 3 to 6, the stacked electrode assembly 110 will be explained. The electrode assembly 110 may be formed by sequentially stacking the first electrode plate 111, the separator 113, and the second electrode plate 112, each formed in a thin plate shape or film shape, in a rectangular parallelepiped shape. That is, the electrode assembly 110 may be formed by sequentially stacking the separator 113, the first electrode plate 111, an additional separator 113, and the second electrode plate 112 in a third direction (e.g., in the z-axis direction) multiple times in a rectangular parallelepiped shape.

The first electrode plate 111 may be formed by applying a first electrode active material 111b, such as graphite or carbon, to a first electrode collector plate 111a formed of a metal foil, such as aluminum. The first electrode plate 111 may include or may be referred to as a positive electrode. The first electrode active material 111b may be provided on one side or both sides of the first electrode current collector 111a. A first electrode uncoated portion 111c may be provided in a region of the first electrode current collector 111a, to which the first electrode active material 111b is not applied. In the first electrode uncoated portion, an uncoated portion positioned at one end of the first electrode current collector 111a in the first direction (e.g., in the x-axis direction) will be referred to as the first electrode uncoated portion 111c. The first electrode uncoated portion 111c may include a first electrode tab 111ca which is a passage for the flow of current between the first electrode plate 111 and the outside of the positive electrode.

The first electrode tab 111ca may protrude from one end of the first electrode plate 111 in a first direction (x) which is the longitudinal direction of the first electrode plate 111. In addition, the first electrode uncoated portion 111c may protrude farther than the first electrode active material 111b to the one end of the first electrode plate 111 in the first direction (x). In addition, the first electrode uncoated portion 111c may extend farther than the first electrode active material 111b to one end of the first electrode plate 111 in the first direction (x) where the first electrode tab 111ca is located. That is, the first electrode plate 111 has the first electrode uncoated portion 111c that protrudes farther than (e.g., beyond) the first electrode active material 111b at the one end in the first direction (x), and the first electrode tab 111ca may be a region that protrudes and extends in the first direction (x) farther than (e.g., beyond) the first electrode uncoated portion 111c (FIG. 6).

At the one end in the first direction (x), the first electrode tab 111ca may be located at one side in a second direction (y), e.g., the first electrode tab 111ca may be shifted in the second direction (y) along an edge of the first electrode current collector 111a (FIG. 4). The first electrode tabs 111ca of the multiple first electrode plates 111 may be stacked and aligned at the same position in the third direction (z) in the electrode assembly 110.

The electrode assembly 110 may further include an insulating layer 114 provided to cover the first electrode uncoated portion 111c located at the one end in the first direction (x) and a portion of one side or both sides of the first electrode tab 111ca. The insulating layer 114 may be provided to cover the first electrode uncoated portion 111c, and may be provided in a region adjacent to the first electrode active material 111b in the first electrode tab 111ca (e.g., the insulating layer 114 may be only on the first electrode plate 111 among the first and second electrode plates 111 and 112).

Referring to FIG. 5, one end (e.g., a first end) of the insulating layer 114 in the first direction (x) may be in contact with the first electrode active material 111b. The insulating layer 114 may entirely cover one end of the first electrode active material 111b, which is a sidewall 111ba of the first electrode active material 111b. The insulating layer 114 may entirely (e.g., and continuously) cover the sidewall 111ba of the first electrode active material 111b that is a lateral surface extending in the third direction (z).

As further illustrated in FIG. 5, the first electrode active material 111b may have a region (A) overlapping the insulating layer 114 in the third direction (z) as well as in the first direction (x). The first electrode active material 111b may have a smaller thickness in a region adjacent to the sidewall 111ba than in other regions. For example, the first electrode active material 111b may gradually decrease in thickness toward the end of the sidewall 111ba. The thickness of the region (A) in the third direction (z), where the first electrode active material 111b and the insulating layer 114 overlap in the first direction (x), may be equal to or smaller than the thickness 111bt of the first electrode active material 111b. The insulating layer 114 may be provided to cover the sidewall 111ba of the first electrode active material 111b, thereby increasing bonding strength. The thickness (114t) of the insulating layer 114 in the third direction (z) may be equal to or smaller than the thickness (111bt) of the first electrode active material 111b. The insulating layer 114 will be described in detail below.

The other end (e.g., a second end) of the insulating layer 114, opposite to the one end in the first direction (x), may be located on the surface of the first electrode tab 111ca (FIG. 6). That is, the length of the insulating layer 114 covering the first electrode tab 111ca in the first direction (x) may be smaller than the length of the first electrode tab 111ca (e.g., so a portion of the first electrode tab 111ca may be exposed and protrude beyond the insulating layer 114 in the first direction (x)). In addition, the width of the insulating layer 114 covering the first electrode tab 111ca in the second direction (y) may be the same as the width of the first electrode tab 111ca (e.g., so the first electrode tab 111ca may be completely covered by the insulating layer 114 in the second direction (y)). In addition, the width of the insulating layer 114 covering the first electrode uncoated portion 111c may be the same as the width of the first electrode uncoated portion 111c (e.g., so the first electrode uncoated portion 111c may be completely covered by the insulating layer 114 in the second direction (y)). In addition, the length of the insulating layer 114 covering the first electrode uncoated portion 111c in the first direction (x) may be the same as the length of the first electrode uncoated portion 111c (e.g., so the first electrode uncoated portion 111c may be completely covered by the insulating layer 114 in the first direction (x)).

The first electrode plate 111 may be provided with the insulating layer 114, which prevents the second electrode plate 112 and the first electrode tab 111ca from being brought into contact with each other, thereby improving safety by preventing an electrical short circuit within the electrode assembly. The insulating layer 114 may include ceramic materials. For example, the insulating layer 114 may include at least one of alumina (Al₂O₃), zirconia (ZrO₂), and titanium oxide (TiO₂).

The first electrode plate 111 may be formed by applying the first electrode active material 111b and the insulating layer 114 to the first electrode current collector 111a, which is a roll-type metal foil, and may then be separated into individual first electrode plates 111, each having the first electrode tab 111ca by punching.

The multiple first electrode tabs 111ca may be electrically connected to one first electrode lead tab 130 and may extend and protrude from the inside to the outside of the case 120. The first electrode lead tab 130 may be shaped of a flat plate that is thicker than the first electrode tab 111ca. In addition, the first insulation tape 131 may be further interposed between the first electrode lead tab 130 and the case 120. The first insulation tape 131 may secure an electrical insulation state between the case 120 and the first electrode lead tab 130.

The first electrode plate 111 may have a smaller size (e.g., length) in each of the first direction (x) and the second direction (y) than the second electrode plate 112 in consideration of a lithium ion precipitation phenomenon that may occur intermittently in the second electrode plate 112 during charging. That is, the second electrode plate 112 may have a larger planar size than the first electrode plate 111.

The second electrode plate 112 may be formed by applying a second electrode active material, such as a transition metal oxide, to a second electrode current collector formed of a metal foil, such as copper or nickel. The second electrode plate 112 may include or may be referred to as a negative electrode. The second electrode active material may be provided on one side or both sides of the second electrode current collector. A second electrode uncoated portion, which is a region to which a second electrode active material is not applied, may be provided in a region of the second electrode current collector. In addition, the second electrode uncoated portion may include a second electrode tab 112c which is a passage for the flow of current between the second electrode plate 112 and the outside of the negative electrode. The second electrode tab 112c may protrude from one end of the second electrode plate 112 in the first direction (x). In addition, at the one end of the second electrode plate 112 in the first direction (x), the second electrode tab 112c may be located at the other side in the second direction (y). That is, the second electrode tab 112c may protrude in the same direction as the first electrode tab 111ca and may be arranged parallel to the first electrode tab 111ca. The second electrode tabs 112c of the multiple second electrode plates 112 may be stacked and aligned at the same position in the third direction (z) in the electrode assembly 110.

The second electrode plate 112 may be formed by applying a second electrode active material to a second electrode current collector, which is a roll-type metal foil, and may then be separated into individual second electrode plates 112 each having the second electrode tab 112c by punching.

In addition, the multiple second electrode tabs 112c may be electrically connected to one second electrode lead tab 140 and may extend and protrude from the inside to the outside of the case 120. The second electrode lead tab 140 may be shaped of a flat plate that is thicker than the second electrode tab 112c. In addition, a second insulation tape 141 may be further interposed between the second electrode lead tab 140 and the case 120. The second insulation tape 141 may secure an electrical insulation state between the case 120 and the second electrode lead tab 140.

The separator 113 may be positioned between the first electrode plate 111 and the second electrode plate 112 to prevent electrical shorts and serves to enable the movement of transition metal ions. The separator 113 may be made of, e.g., polyethylene, polypropylene, or a composite film of polyethylene and polypropylene.

In order to more securely prevent a short circuit between the first electrode plate 111 and the second electrode plate 112, the separator 113 may be formed to have a larger width and length in both the first direction (x) and the second direction (y) than the first electrode plate 111 and the second electrode plate 112. That is, the separator 113 may have a larger planar size than the first electrode plate 111 and the second electrode plate 112.

The electrode assembly 110 may be of a stack type in which a stack of the first electrode plate 111, the separator 113, the second electrode plate 112, and the separator 113, is repeatedly stacked multiple times. Each first electrode plate 111 may include the insulating layer 114, and the insulating layers 114 on the stacked first electrode plates 111 may have different thicknesses in the third direction (z) depending on the stacking position of the insulating layer 114 in the third direction (z). For example, referring to FIG. 6, the insulating layer 114 may have a thicker outermost insulating layer 114c formed on the outermost first electrode plate 111 located at the outermost side in the third direction (z) (e.g., topmost and bottommost positions in the orientation of FIG. 6), as compared to a central insulating layer 114a formed on the first electrode plate 111 centrally located in the third direction (z), which is the thickness direction of the electrode assembly 110. In addition, the thickness of an inner insulating layer 114b formed on the inner first electrode plate 111 located between the central first electrode plate 111 and the outermost first electrode plate 111 in the electrode assembly 110 may be greater than or equal to that of the central insulating layer 114a. Here, although the inner first electrode plate 111 is shown as one, multiple inner first electrode plates 111 may be provided.

For example, the thickness (Tc) of the outermost insulating layer 114c may be greater than each of the thickness (Tb) of the inner insulating layer 114b and the thickness (Ta) of the central insulating layer 114a. For example, the thickness of the insulating layer may be the thickness of the insulating layer formed on the first electrode uncoated portion 111c and the first electrode tab 111ca of the first electrode plate 111. The thickness of the insulating layer means the average thickness of the insulating layer covering the first electrode uncoated portion 111c and the first electrode tab 111ca, excluding the region (A) overlapping with the first electrode active material 111b. In addition, the thickness (Tb) of the inner insulating layer 114b may be greater than or equal to the thickness (Ta) of the central insulating layer 114a. That is, the thickness of the insulating layer 114 may sequentially increase from the center toward the outermost side, or other insulating layers except for the outermost insulating layer 114c may have a uniform thickness.

For example, the thickness (Tb) of the inner insulating layer 114b and the thickness (Ta) of the central insulating layer 114a may be 50% to 90% of the thickness (Tc) of the outermost insulating layer 114c. In addition, the thickness (Tb) of the optimal inner insulating layer 114b and the thickness (Ta) of the optimal central insulating layer 114a may be 60% to 65% of the thickness (Tc) of the outermost insulating layer 114c. In addition, the thickness (Tc) of the outermost insulating layer 114c may be 40% to 70% of the thickness of the first electrode active material 111b.

The electrode assembly 110 can improve electrical insulation properties by thickly forming the outermost insulating layer 114c that is most susceptible to damage by external force. In addition, by more thinly forming the inner insulating layer 114b and the central insulating layer 114a provided on the first electrode plate 111 having a low damage rate due to external force than the outermost insulating layer 114c, the electrode assembly 110 can prevent a decrease in the overall capacity due to an increase in the weight and thickness of the insulating layer. That is, by thickly forming the outermost insulating layer 114c provided on the outermost first electrode plate 111 and more thinly forming the other insulating layers 114a, 114b than the outermost insulating layer 114c, the electrode assembly 110 can improve safety against external force while simultaneously reducing cell resistance and maximizing capacity.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤c≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤a≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector (e.g., a first substrate) and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector (e.g., a second substrate) and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

As described above, in the lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

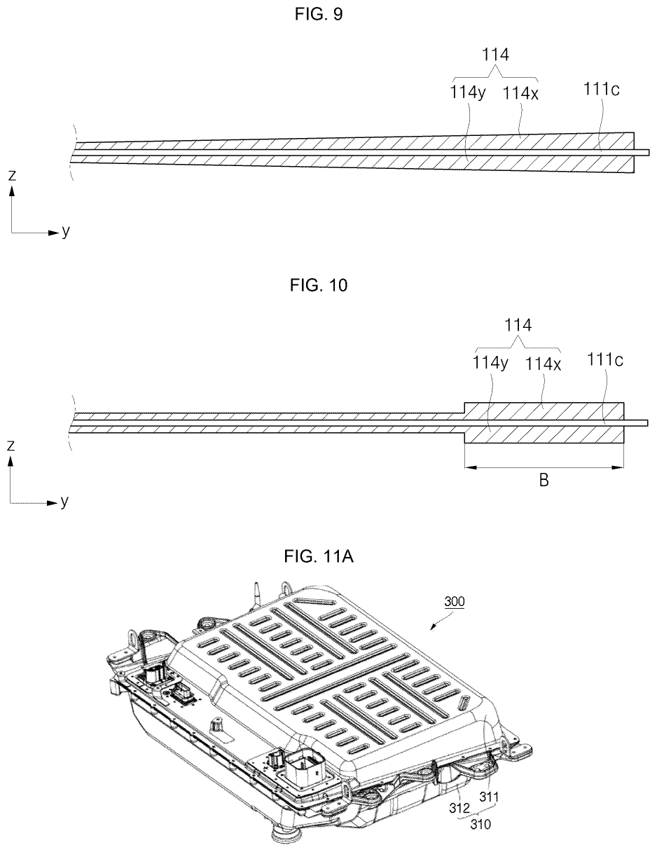

FIG. 7 is a perspective view showing another example of the electrode assembly in the secondary battery of FIGS. 1 and 2. In addition, FIG. 8 is a plan view showing the electrode assembly of FIG. 7 before a first electrode plate 111 is wound. In addition, referring to FIG. 9, an example of a cross-sectional view taken along line 9-9′ of FIG. 8 is shown.

Referring to FIGS. 7 to 9, the electrode assembly 110 may be formed by stacking the first electrode plate 111, the separator 113, and the second electrode plate 112, and then winding the stack in a jelly-roll shape.

For example, the first electrode plate 111 may be formed by applying the first electrode active material 111b, such as a transition metal oxide, to the first electrode current collector 111a formed of a metal foil, such as aluminum, and may include the first electrode tab 111ca extending and protruding from the first electrode uncoated portion 111c which is a region to which the first electrode active material 111b is not applied. The first electrode plate 111 may further include the insulating layer 114 provided to cover the first electrode uncoated portion 111c located at one end in the first direction (x) and a portion of one side or both surfaces of the first electrode tab 111ca. The insulating layer 114 may be provided to cover the first electrode uncoated portion 111c, and may be provided in a region adjacent to the first electrode uncoated portion 111c in the first electrode tab 111ca.

The first electrode tab 111ca may be provided as multiple first electrode tabs 111ca. At one end of the wound electrode assembly 110 in the first direction (x), the first electrode tab 111ca may be positioned at one side in the second direction (y). The first electrode tabs 111ca of the wound first electrode plate 111 may be aligned at the same position in the third direction (z) in the electrode assembly 110. The insulating layer 114 may be similar to the stacked electrode assembly 110 shown in FIGS. 4 and 5 in terms of the shape and structure cut out in the first direction (x).

However, the insulating layer 114 may have a gradient such that the thickness thereof gradually increases from the winding leading edge (e.g., an innermost edge closer to the inner core and starting the winding of the electrode assembly) to the winding trailing edge (e.g., an outermost edge of the electrode assembly opposite the innermost edge and closer to the exterior of the electrode assembly) along the second direction (y), which is the winding direction. For example, the insulating layer 114 may have the smallest thickness at the winding leading edge and the largest thickness at the winding trailing edge. The thickness of the insulating layer 114 at the winding trailing edge may be 40% to 70% of the thickness of the first electrode active material 111b. In addition, the thickness of the insulating layer 114 at the winding leading edge may be 50% to 90% of the thickness of the winding trailing edge. In addition, the optimal thickness of the insulating layer 114 at the winding leading edge may be 60% to 65% of the thickness of the insulating layer 114 at the winding trailing edge.

In addition, in the case of the coiled electrode assembly 110, the inner insulating layer 114x, which is an insulating layer provided on the inner side located on the inner side of the first electrode current collector 111a during winding, may be provided to have a smaller thickness than the outer insulating layer 114y, which is an insulating layer provided on the outer side opposite to the inner side. Here, the inner side may be a side facing a winding core, and the outer side may be a side facing the outside, during winding.

In addition, in the first electrode plate 111, the thickness of the first electrode active material 111b provided on the outer surface may be equal to or greater than that of the first electrode active material 111b provided on the inner surface of the first electrode collector plate 111a.

The electrode assembly 110 may improve electrical insulation properties by providing a thicker insulating layer on the outer side, which is most susceptible to damage due to external force, and by providing a winding trailing edge having a larger thickness than the winding leading edge. In addition, by more thinly forming the inner insulating layer 114 on the inner surface and winding leading edge of the first electrode plate 111, which has a lower damage rate than the outer surface of the first electrode plate 111 and the winding trailing edge, the electrode assembly 110 may prevent a decrease in the overall capacity due to an increase in the weight and thickness of the insulating layer. That is, by adjusting the thickness of the insulating layer 114 provided for each region, the electrode assembly 110 may improve safety against external force while simultaneously reducing cell resistance and maximizing capacity.

FIG. 10 is another example of a cross-sectional view along line 9-9′ of FIG. 8.

Referring to FIG. 10, the insulating layer 114 of the first electrode plate 111 shown in FIG. 10 may be similar to the insulating layer shown in FIG. 9, but the insulating layer 114 may be provided to be stepped such that the insulating layer 114 located at the winding trailing edge is thicker than the insulating layers 114 located in other regions. That is, the insulating layer 114 may be provided with a uniform thickness in the winding leading edge region, which is a certain region along the second direction (y) from the winding leading edge, and the thickness of a winding trailing edge region (B) may be provided to be larger than that of other regions. Here, the winding trailing edge region (B) may correspond to a length in which the first electrode plate 111 located at the outermost side, is wound at least once. The insulating layer 114 may have a thickness of 50% to 100% of the thickness of the first electrode active material 111b in the winding trailing edge region (B). In addition, the thickness of the insulating layer 114 in the winding leading edge region may be 50% to 90% of the thickness of the winding trailing edge region (B). In addition, the optimal thickness of the insulating layer 114 in the winding leading edge region may be 60% to 65% of the thickness of the insulating layer 114 in the winding trailing edge region (B).

In addition, the second electrode plate 112 may be formed by applying a second electrode active material, such as a transition metal oxide, to the second electrode current collector 112a formed of a metal foil, such as copper or nickel, and includes the second electrode tab 112c extending and protruding from a second electrode uncoated portion, which is a region to which a second electrode active material 112b is not applied, at one end of the wound electrode assembly 110 in the first direction (x). The second electrode tab 112c may be located at the other end in the second direction (y). The second electrode tabs 112c of the wound second electrode plates 112 may be aligned in the same position in the third direction (z) in the electrode assembly 110.

The separator 113 may be positioned between the first electrode plate 111 and the second electrode plate 112 to prevent electrical shorts and serves to enable the movement of transition metal ions, and may be made of polyethylene, polypropylene, or a composite film of polyethylene and polypropylene. The separator 113 may be similar to the separator 113 described with reference to FIGS. 1 and 6.

Referring back to FIGS. 1-2, the case 120 may include a case body part 121 and a case cover 122, in which a rectangular film extending in the first direction (x), which is the longitudinal direction of the case 120, is folded. The case 120 may accommodate either of the electrode assemblies described previously with reference to FIGS. 1-10.

In addition, the case 120 may be coupled and sealed to the case body part 121 by folding the case cover 122 after the electrode assembly 110 is accommodated in a recess 123 provided in the case body part 121. For example, the case 120 may be referred to as a pouch for a secondary battery.

The case 120 may be formed by folding a rectangular film extending along the first direction x with respect to a folding part 124 extending along the second direction (y), which is perpendicular to the first direction (x) and the width direction of the case 120. In another example, the case body part 121 and the case cover 122 may be formed as separate members, in which case the folding part 124 may not be provided. For example, referring to FIG. 2, the case 120 may be an integral type in which the case body part 121 and the case cover 122 are formed on a single (e.g., a continuous and rectangular) film. However, the structure of the case may vary and the case body part 121 and the case cover 122 may not be formed on a single rectangular film (e.g., may be formed separately and attached to each other).

The case cover 122 may have a rectangular flat plate shape. The case cover 122 may be in contact with and be coupled to the case body part 121 through the folding part 124. The case cover 122 may cover the upper portion of the case body part 121.

In addition, the case body part 121 may include the recess 123 and an extension part 125. The case body part 121 may include the recess 123 having the electrode assembly 110 received at approximately the center thereof, and the extension part 125 extending approximately outwardly from three sides of the recess 123. For convenience of explanation, around the recess 123 sealed with the edge of the case cover 122, the edge of the case body part 121 located on the outer side in a plane is defined as the extension part 125. That is, the extension part 125 may be a surface that is parallel to and combined with the case cover 122. The recess 123 of the case body part 121 may be sized enough to accommodate the electrode assembly 110 through a pressing or drawing process, etc. In addition, the extension part 125 may extend outwardly from three or four sides of recess 123.

In another example, when the case body part 121 and the case cover 122 are formed as separate members, the extension part 125 may also be provided in a region where the folding part 124 is located. In yet another example, when the case body part 121 and the case cover 122 are formed as one piece, the extension part 125 may also be provided in the case body part 121 adjacent to the folding part 124. The case body part 121 may be combined and sealed by heat-fusing the edge of the recess 123 and the edge of the case cover 122 after the case cover 122 covers the portion where the recess 123 is formed.

The secondary battery 100 of the present disclosure is shown as having the electrode assembly 110 accommodated within the pouch-shaped case 120, but cases having various shapes can be applied. For example, the secondary battery 100 may be a cylindrical secondary battery including a cylindrical case and a cap plate that seals an open end of the cylindrical case. In another example, the secondary battery 100 may be a square secondary battery including a square case having one open side in a roughly hexahedral shape, and a cap plate sealing the open side of the square case. In yet another example, the secondary battery 100 may be a prismatic secondary battery having a side terminal structure, including a prismatic case having two open opposite sides in a roughly hexahedral shape, and two cap plates that seal each of the open sides of the prismatic case. In addition, in the case of prismatic or cylindrical batteries, when an electrode uncoated portion serves as a tab, an insulating layer may be provided only on the electrode uncoated portion without forming a separate tab.

The secondary battery according to the above-described embodiment can be used to manufacture a battery pack.

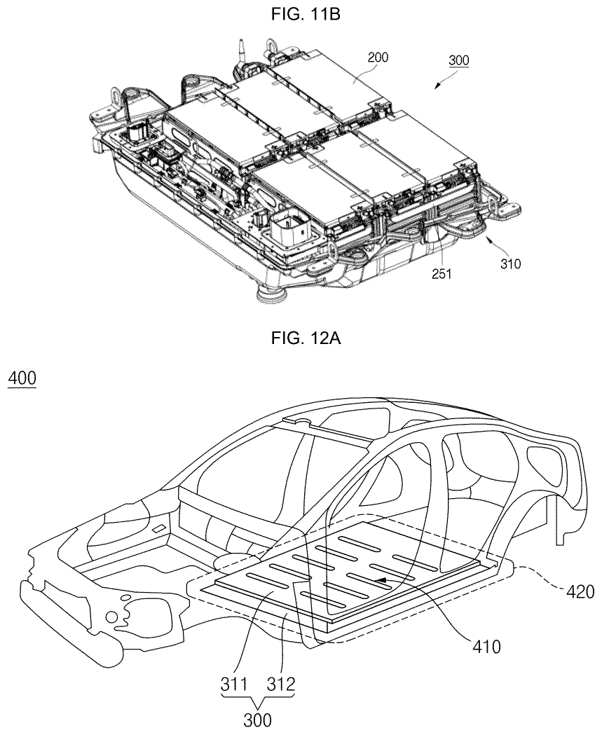

FIGS. 11A and 11B are perspective views showing an exemplary battery pack 300. Referring to FIGS. 11A and 11B, the battery pack 300 may include a plurality of battery modules 200 and a housing 310 configured to accommodate the plurality of battery modules 200. For example, the housing 310 may include a first housing 311 and a second housing 312, which are coupled to each other in directions facing each other with the plurality of battery modules 200 interposed therebetween. The plurality of battery modules 301 may be electrically connected to each other using bus bars 251. The plurality of battery modules 200 may be electrically connected to each other in series, in parallel, or in a combination thereof, so that desired electrical output may be obtained. In the drawings, for the sake of convenient illustration, components such as bus bars, cooling units, and external terminals for the electrical connection of battery cells are not illustrated. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

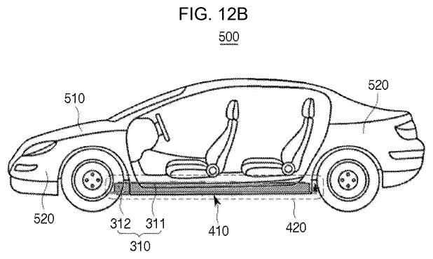

FIGS. 12A and 12B are, respectively, a perspective view and a side view showing vehicles 400 and 500 each including the exemplary battery pack 300. As shown in FIG. 12A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 12B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

The present disclosure provides a secondary battery capable of improving electrical insulation characteristics by providing an insulating layer located on the outer side of an electrode assembly, which is most susceptible to damage due to external force, so as to have a larger thickness than an insulating layer located on the inner side, and at the same time preventing a decrease in the overall capacity of an electrode assembly due to an increase in the weight and thickness of an insulating layer.

However, the technical effects to be achieved in the embodiment of the disclosure are not limited to the aspects mentioned above, and other technical effects not mentioned herein will be clearly understood from the above description by those skilled in the art to which the disclosure belongs.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode plate having a first electrode uncoated portion, a second electrode plate having a second electrode uncoated portion, and a separator between the first electrode plate and the second electrode plate;
an insulating layer covering the first electrode uncoated portion, a thickness of the insulating layer on the first electrode uncoated portion at an outer side of the electrode assembly being greater than a thickness of the insulating layer on the first electrode uncoated portion at an inner side of the electrode assembly; and
a case accommodating the electrode assembly with the insulating layer.

2. The secondary battery as claimed in claim 1, wherein the first electrode plate includes:
a first electrode current collector plate which is a metal foil;
a first electrode active material on at least one surface of the first electrode current collector plate; and
the first electrode uncoated portion at one end in a first direction of the first electrode current collector plate, the first electrode active material not being on the first electrode uncoated portion.

3. The secondary battery as claimed in claim 2, wherein the insulating layer includes a first end covering a sidewall of the first electrode active material.

4. The secondary battery as claimed in claim 3, wherein the insulating layer includes a region overlapping the first electrode active material in the first direction.

5. The secondary battery as claimed in claim 3, wherein the insulating layer includes a second end opposite the first end in the first direction, the second end being on the first electrode uncoated portion and having a thickness that is equal to or smaller than a thickness of the first electrode active material.

6. The secondary battery as claimed in claim 3, wherein the insulating layer includes a second end opposite the first end in the first direction, the second end being on the first electrode uncoated portion and having a thickness that is 40% to 70% of a thickness of the first electrode active material.

7. The secondary battery as claimed in claim 2, wherein the first electrode active material is on each of opposite sides of the first electrode current collector, the insulating layer being on each of opposite sides of the first electrode uncoated portion.

8. The secondary battery as claimed in claim 1, wherein:
the electrode assembly is a stack type in which the first electrode plate, the separator, the second negative electrode plate, and an additional separator are sequentially and repeatedly stacked multiple times; and
a thickness of an outermost insulating layer on the first electrode plate at an outermost side of the electrode assembly is greater than a thickness of an inner insulating layer on the first electrode plate at the inner side of the electrode assembly.

9. The secondary battery as claimed in claim 8, wherein the thickness of the inner insulating layer is 50% to 90% of the thickness of the outermost insulating layer.

10. The secondary battery as claimed in claim 8, wherein a thickness of the insulating layer on the first electrode plate at a center of the electrode assembly is smaller than a thickness of the insulating layer on another first electrode plate.

11. The secondary battery as claimed in claim 8, wherein:
the electrode assembly includes a plurality of the first electrode plate, and
each of the plurality of the first electrode plate further includes a first electrode tab extending in a first direction from the first electrode uncoated portion, the insulating layer partially covering a surface of the first electrode tab.

12. The secondary battery as claimed in claim 11, wherein the insulating layer has a smaller length in the first direction than a length of the first electrode tab in the first direction.

13. The secondary battery as claimed in claim 11, wherein the first electrode tab is aligned and stacked with an adjacent first electrode tab in a same position.

14. The secondary battery as claimed in claim 1, wherein the electrode assembly is of a jelly-roll type in which the first electrode plate, the separator, the second negative electrode plate, and an additional separator are sequentially stacked in a plate or film shape.

15. The secondary battery as claimed in claim 14, wherein the insulating layer gradually increases in thickness from a winding leading edge to a winding trailing edge.

16. The secondary battery as claimed in claim 14, wherein a thickness of the insulating layer covering an outer surface of the first electrode uncoated portion is greater than a thickness of the insulating layer covering an inner surface of the first electrode uncoated portion.

17. The secondary battery as claimed in claim 14, wherein:
the insulating layer at a winding trailing edge region, which is an outermost side of the electrode assembly, has a larger thickness than the insulating layer at an inner region, which is the inner side of the electrode assembly, and
the winding trailing edge region corresponds to a length in which the first electrode plate at the outermost side of the electrode assembly is wound at least once.

18. The secondary battery as claimed in claim 17, wherein the insulating layer in the inner region has a uniform thickness.

19. The secondary battery as claimed in claim 1, wherein the first electrode plate is a positive electrode plate, and the second electrode plate is a negative electrode plate.

20. The secondary battery as claimed in claim 1, wherein the insulating layer includes a ceramic.
